(19) United States
(12) Patent Application Publication
(10) Pub. No.: US 2003/0065720 A1
(43) Pub. Date: Apr. 3, 2003

(54) System and method for on-line participation in memorial services for space burials and the like

(76) Inventor: Charles M. Chafer, Houston, TX (US)

Correspondence Address: TRACY W. DRUCE, KILPATRICK STOCKTON LLP, 11130 SUNRISE VALLEY DRIVE, SUITE 300, RESTON, VA, 20191-4329, US

(21) Appl. No.: 09/966,320

(22) Filed: Sep. 28, 2001

Related U.S. Application Data
(60) Provisional application No. 60/236,172, filed on Sep. 29, 2000.

(51) Int. Cl. G06F 15/16

(52) U.S. Cl. 709/204; 709/206

(57) ABSTRACT

A novel on-line method and system for public participation in, for example, space burials is provided. Methods of customized user participation in a memorial service for a space burial, include, for example, providing a web site or other graphical user interface for users to access via the Internet or via another computer network, displaying a webcast via the web site of a memorial service on behalf of at least one deceased individual having remains included in a space burial mission, and having users supplement the webcast with customized content and interact remotely from remote computers connected to the computer network.

### CROSS REFERENCE TO RELATED APPLICATIONS

This application claims priority to, and herein incorporates by reference in its entirety, applicant's copending U.S. Provisional Application No. 60/236,172 filed Sept. 29, 2000.

### BACKGROUND OF THE INVENTION

1. Field of the Invention The present invention relates generally to providing customized observance of an event broadcasted to participants over a communication network. More particularly, the present invention provides for customized participation by the public in space-burial memorial services via the Internet.

2. Background of the Invention Group participation in a live event usually subjects all participants to a common experience during the event, whether the event is a sporting event, conference, memorial service, ceremonies, etc. For example, when the lives of the deceased are celebrated or honored with burial or memorial services, participants customarily come together at a central site and share in a common ceremony. The gathering of participants to mourn in the presence of the deceased, however, is often not practical or possible.

Recently, the assignee of the present invention, Celestis, Inc., has made giant leaps in methods for celebrating the lives of individuals upon their deaths. Celestis has successfully launched cremation burial space flights—e.g., including space burials of the famous celebrities Timothy Leary and Gene Roddenberry—in which the ashes of individuals have been sent into orbit around the earth and have been hard-landed onto the surface of the moon.

This burial method is in stark contrast to the traditional methods of underground graves, encapsulating tombs, and burial at sea, including memorial services with eulogies, prayers and the like on behalf of the deceased. In many cases, burials include permanent memorials and/or testaments, e.g., grave stones, etc., to provide family and/or friends with a site to visit in memory of the deceased.

With the advent of space burials, there is an ever-present need for improved methods to honor, memorialize and remember loved ones after their death.

Accordingly, there is a need for a system and method for meaningful public participation in space-burial memorial services over an on-line computer network such as the Internet.

### SUMMARY OF INVENTION

The present invention overcomes limitations in existing burial or other ceremonial services where the gathering of participants at an ideal location is not practical or possible. The present invention enables participants to not only join others in experiencing an event, but also to customize their experience. For example, participants witnessing a burial ceremony may practice different religions and may wish to honor the deceased pursuant to their own religious teachings.

The present invention provides a system and method for allowing a customized observance of an event wherein the event is broadcasted in real-time or near real-time via the Internet. The participants are then able to customize their observance of the event with supplemental video, text, and audio chosen by the participants. In this way, not only is there a virtual assemblage of different groups observing a common event, the participation of these groups becomes much more meaningful.

For example, geographically separated mourners at a burial ceremony may supplement their viewing of the ceremony with streaming video about the deceased, or talk among themselves, or broadcast a eulogy to certain groups of people in certain languages. Embodiments of the present invention include multiple interest groups, or stations, equipped with video and audio capture and compress subsystems, and decompress and display subsystems. The communication media between the participant stations can include, but is not limited to POTS (Plain Old Telephone System), LAN (Local Area Network), or WAN (Wide Area Network), etc.

A common software architecture for one arrangement of the present invention comprises an interest group participation application, customization/interaction middleware, video and audio compression/decompression (codec) and data, stream multiplexer and demultiplexer, and line drivers.

Further embodiments of the present invention provide for dynamic session control wherein the inventive system has the ability to add and delete participants from various ceremonies. Additional embodiments of the present invention involve interactions that are one to one (point-to-point) or one-to-many (multipoint), in simplex (one-way only), half duplex (one way at a time, taking turns) or full-duplex (all parties are seen and heard simultaneously).

Another embodiment of the invention involves a method for broadcasting an event comprising broadcasting an event to at least two recipients in disparate geographical locations wherein each recipient is assigned to at least one of multiple interest groups and supplementing the broadcast with content broadcasted to at least one of the multiple interest groups.

According to another embodiment of the invention, users participate in a space burial through a method providing a server programmed to create a web site or graphical user interface accessible via the Internet. The method further provides a space vehicle having a deceased individual cargo section, wherein video images of the space vehicle are obtained during the travel of the vehicle. The method also includes creating an Internet or computer network broadcast of the video images and having members of the public access and view the broadcast via a local computer over the Internet in substantially real-time.

According to another embodiment of the invention, a method is provided for personalizing a space burial service. The method includes providing a server programmed to create a web site; providing a space vehicle having a deceased individual cargo section; and having an individual access the web site via the Internet at a local computer remote from the server. The method further involves inputting information via the web site related to a memorial service on behalf of the deceased and adapting an on-line memorial service based on the information submitted. In a further embodiment of the present invention, users participate in the memorial service by submitting statements on-line from remote computers connected to the computer network.

Additional aspects, advantages and novel features of the invention will be set forth in part in the description that follows, and in part will become more apparent to those skilled in the art upon examination of the following or upon learning by practice of the invention.

### Brief Description of Drawings

The present invention is shown by way of example and not limitation in the accompanying figures, in which:

FIG. 1 is a diagram of system components for video, text, and audio interaction between participants participating in a common event in accordance with one arrangement of the invention;

FIG. 2 is a software architecture for video, text, and audio interaction between participants participating in a common event in accordance with another arrangement;

FIG. 3 is a schematic diagram showing a spacecraft, having a deceased individual cargo section, distant from the earth's surface;

FIG. 4 is a schematic diagram of a system for presenting an interactive web site for public participation in space-burial memorial services; and

FIG. 5 is an illustrative web page that may be displayed on user local computers for participation in space-burial memorial services and the like.

### DETAILED DESCRITION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents.

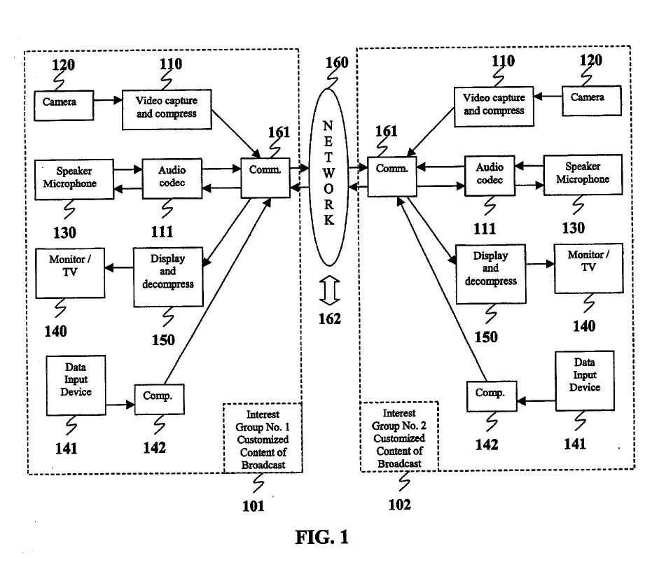

The illustrated embodiments of the present invention provide systems and methods for on-line user participation in space burials via a computer network such as the Internet. Components for conducting on-line multiple user participation in accordance with one arrangement of the invention is illustrated in FIG.1. This arrangement, as well as other known system configurations, provide a full range of audio, video, and text supplementation for the observance of an event by multiple interest groups 101, 102. The system comprises video and audio capture and compress subsystems 110 and 111, cameras 120, speakers and microphones 130, monitors 140, decompress and display subsystems 150, data input devices 141 and computers 142 (including microcomputers, e.g., personal digital assistants, etc).

Included is communication 161 to a network 160 (POTS, LANs, WAN, etc.). Further communication media 162 may provide the satellite transmission of a broadcasted event, etc. or connection to other networks.

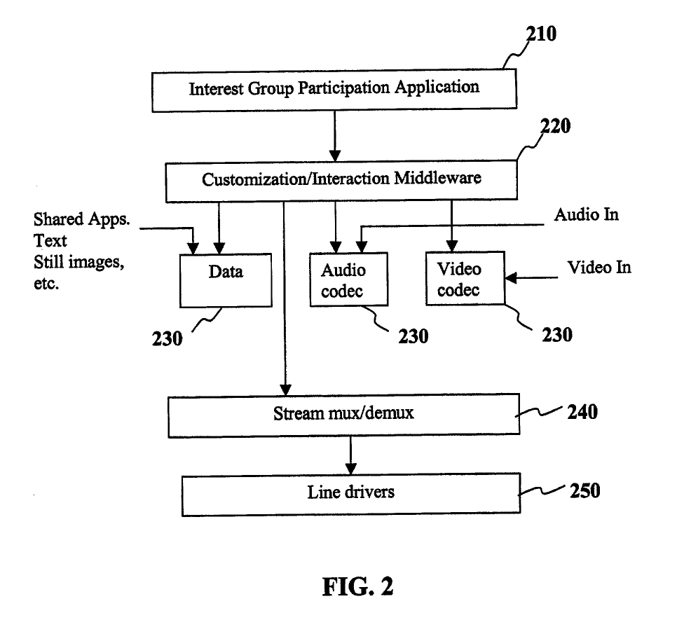

FIG. 2 illustrates a corresponding software architecture which comprises an interest group participation application 210, customization/interaction middleware 220, video and audio codec and data 230, stream multiplexer and demultiplexer 240, and line drivers 250. Networks include, but are not limited to ISDN, IP, packet-data LANs, ATM networks, analog phone lines, the Internet, etc. Network configurations comprise fully distributed (mesh) networks, centralized (star) networks, double-star networks, hierarchical networks, etc.

I. Space Burials

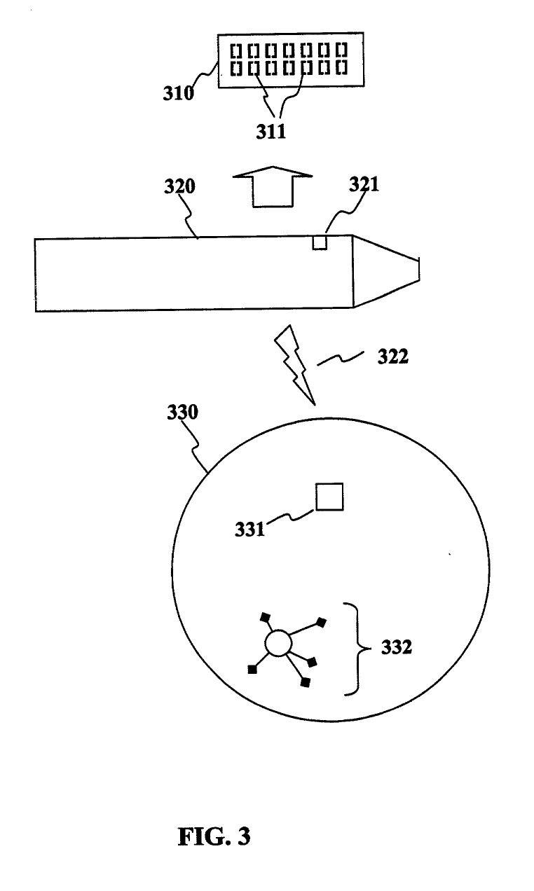

According to preferred embodiments of the invention, in space burials at least a portion of the remains of at least one deceased individual is included as cargo on a vehicle that is launched from the surface of the earth into space. FIG. 3 shows one illustrative embodiment according to the present invention. In the illustrated embodiment, a spacecraft 310 is configured to contain a multitude of containers 311 that are configured to hold some or all of the remains of deceased individuals. In preferred embodiments, the remains are ashes of the deceased. In some preferred embodiments, only a small portion of the deceased's “ remains are included, such as in just one illustrative example between about 5 to 10 grams per individual. In some preferred embodiments, each container 311 holds the remains of one individual. In other embodiments, each container 311 holds the remains of a number of individuals-such as, for example, a husband and wife. Preferably, a large number of containers can be incorporated in the space burial while limiting the size and weight of the burial cargo. In other embodiments, an entire body of ashes or substantially an entire body of ashes can be included (i.e., ashes of the entire or substantially the entire remains of an individual). In other embodiments, a portion of or the entire content of the body of the deceased can be freeze-dried, dehydrated or otherwise pre-processed to be contained as cargo.

In some embodiments, the burial cargo is launched as a secondary payload. In one exemplary embodiment, it is included on an ARIANE 5 rocket. In one example, the ARIANE 5 rocket can be used to place a small spacecraft in geo-synchronous transfer orbit. At a certain point in time (e.g., coordinated with television broadcasting, web casting, etc.), the spacecraft can be propelled along a particular path—e.g., out of the earth's atmosphere.

In other embodiments, the burial cargo can be provided on a craft or satellite in orbit around the earth. In some preferred embodiments, the orbit around the earth is a geo-synchronous orbit such that the location of the craft or satellite is substantially constant with respect to the surface of the earth. In this manner, for example, the location can be substantially perpetual overhead in the sky. In some embodiments, the craft in orbit around the earth carrying the cargo can be directed to re-enter the earth's atmosphere at a selected time and/or location so as to create a controlled re-entry that creates a visible spectacle in the sky (i.e., similar to a shooting star). This latter embodiment can be combined with a concurrent ceremony or service, preferably broadcasted and/or webcasted in substantially real time.

In other embodiments, the burial cargo can be provided within a craft in orbit around the earth so as to create an orbiting mausoleum. In some embodiments, the orbiting mausoleum can include a multitude of lockers or chambers for containing remains of individuals. The lockers or chambers can be separated by individuals, by families, by classes (e.g., for cultures having different social classes, etc.), by payment level (e.g., higher priced sections, etc.), by religion, etc. In addition to the physical remains cargo, the lockers or chambers can also include other information such as images, photographs and electronic disks containing electronic information or the like.

In some embodiments, the mausoleum can be simply incorporated within a space station. In other embodiments, the mausoleum can be incorporated as an attachment (e.g., an externally attached module or the like) to an existing space station. In other embodiments, the mausoleum can be provided in an independent craft or the like.

In other embodiments, the burial cargo can be provided on a craft that is sent into orbit around the moon. In further embodiments, the burial cargo can be provided on a craft that is directed to impact into the moon—i.e., crash land or hard land on the moon.

In some embodiments, the burial cargo can be provided on a craft that is directed to “soft-land” on the moon. For example, the craft can include reverse thruster engines to substantially retard its approach to the moon's surface. In some preferred embodiments, the soft-landing can be concurrently videoed or filmed for a concurrent memorial service, broadcast, webcast or the like. In some preferred embodiments, the craft that soft lands and deploys the burial cargo onto the surface of the moon will be a return craft (e.g., a manned or unmanned craft) that can return to the earth.

In other embodiments, the burial cargo can be provided on a craft that is directed to hard land or to soft land on the surface of another planet, preferably Mars.

In other embodiments, the burial cargo can be provided on a craft that is directed to follow an orbit around the sun or a solar orbit. In some preferred embodiments, the solar orbit is substantially synchronous with the orbit of the earth around the sun.

In other embodiments, the burial cargo can be provided on a craft that is directed to impact or enter the sun itself.

In other embodiments, the burial cargo can be directed to approach, directed to follow a concurrent path with and/or directed to orbit around another space destination, such as an asteroid, a comet, a star, a solar system, etc.

While the preferred embodiments of the invention pertain to space burials, as described herein, various novel aspects and on-line features of the present invention can also be incorporated in terrestrial and other memorial services, burials, ceremonies or the like.

II. On-Line Interface

In preferred embodiments of the invention, a user interface is provided via a computer network, such as the Internet, a local area network (LAN), a wide area network (WAN), a virtual private network (VPN), or any other network or communication interface, including, for example, via the World Wide Web, via WebTV, or via any other user interface technology.

While in certain preferred embodiments described herein the user interface is applied in space burials, in other embodiments of the invention the user interface can be applied in other burial or memorial services or the like, such as, for example, in terrestrial or earth-based services, including, for example, illustrative services discussed above in the Description of the Related Art. In other embodiments of the invention, the ceremonies do not relate to burials, for example, embodiments include graduation ceremonies, weddings, cultural events, and any other event.

In preferred embodiments, the user interface is provided for user interaction and/or customization, such as in some illustrative examples for: i) entering information (e.g., about the deceased); ii) selecting types of services (e.g., particular religious services, particular styles of services, particular invitees, etc.); and/or iii) participating in services (e.g., pre-recorded or real-time user commentary or eulogies for services).

In some preferred embodiments, this interface can include, for example, online broadcasts for user viewing of a) the launch itself (e.g., in space burial embodiments) and/or b) the memorial service. As also discussed further below, in other embodiments, terrestrial memorials can also be provided for the families and/or friends of the deceased (i.e., terrestrial counterparts) such as, for example: a) table top displays (e.g., having the deceased's information, launch information, pictures, capsule replicas or capsules with ashes, etc.); and/or b) website displays (e.g., having the deceased's information, launch information, pictures, displays of deceased's location, etc.).ln preferred embodiments, an Internet web site or other on-line graphical user interface is provided which includes, for example, on-line forms to enable members of the public to input information and to render payments (e.g., via credit cards, on-line accounts, virtual wallets or the like).

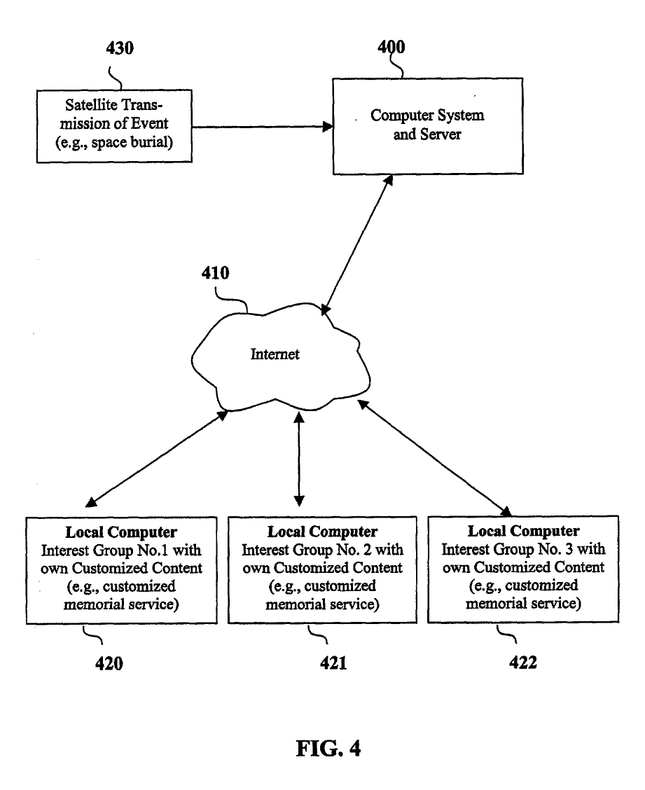

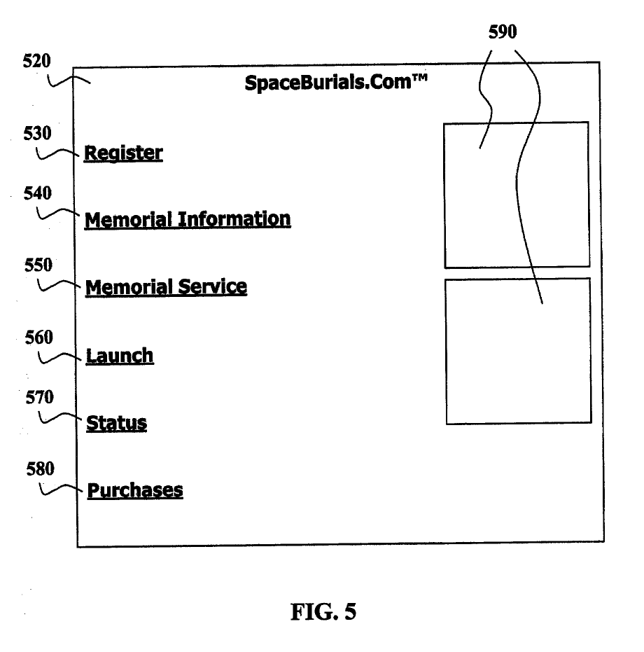

As shown in FIG. 4, preferably, computer 400 (e.g., a server) is connected to the Internet or to another computer network 410 which hosts a web site or the like that is accessed over the Internet or other computer networks 410 via a plurality of remote computers 420, 421, 422 (e.g., local computers such as home personal computers, business computers within local area networks, personal digital assistants, etc., utilizing web browser software or the like). Satellite transmission 430 of the space burial provides the plurality of remote computers 420, 421, 422 customized participation of the memorial service. FIG. 5 illustrates a web page 510 or the like graphical user interface that individuals can access via browser software or the like executing on their local computers 420.

A. Registering And Entering Memorial Information

As shown in FIG. 5, the web page 520 preferably includes a section 530 upon which a user can “click” or otherwise select so as to be directed to an on-line form or the like to submit registration information. For example, information submitted can include a) name and correspondence information related to the individual(s) registering, b) name and correspondence information related to the individual(s) that are to be the points of contact for future communications, c) billing and payment information, d) product selection information (e.g., entering the type of services desired), etc.

The web page 520 preferably also includes a section 540 upon which a user can “click” or otherwise select so as to be directed to an on-line form or the like to submit information pertaining to the deceased and/or information to be included within the memorial service. For example, one can submit: a) a biography, a statement, a eulogy or the like about or on behalf of the deceased; b) photographs, videos or the like of the deceased and/or the deceased's family, etc., and/or c) other information about or related to the deceased. In some preferred embodiments, as described below, information submitted can be presented on an on-line memorial web page for the deceased so as to create an on-line memorial for the deceased.

B. Selecting Memorial Service Features

As shown in FIG. 5, the web page preferably includes a section 550 upon which a user can “click” or otherwise select so as to be directed to an on-line form or the like to select assorted features of the memorial service. For example, users may be able to select one or more of the following: a) a category of a religious service (e.g., Catholic, Hebrew, Buddhist, Moslem or another religion), b) a time duration or length of a service, c) elements to include in the service (e.g., introductory statements, eulogies, etc.) and d) various other aspects and features of the service.

C. On-Line Broadcasts

As shown in FIG. 5, one or more fields 590 is preferably provided for presenting a video image and/or a webcast of one or more aspect of the space burial mission—such as, e.g., the launch of the mission from the earth's surface, the separation of a spacecraft 310 from a carrier craft 320, or the like. The launch 560 selection may be “clicked” to view a video of the launch or other information pertaining to the launch.

In addition, the web site can also be used to create on-line broadcasts or webcasts of actual memorial services themselves. In some embodiments, the services can be conducted at a location remote from the spacecraft, such as on the earth's surface. In some embodiments, the services can be conducted in space—such as, by astronauts and/or other individuals upon a spacecraft, upon a space station, upon a reusable orbital platform such as the space shuttle or upon another space vehicle. In any case, the services are preferably videoed and recorded and broadcasted and/or webcasted in substantially real-time for viewing via the web site or like interface.

Further, the web page 520 has an option for the user to click “Status”570 to receive status information on, but not limited to the following: launch, mission, ceremony, payments, participation, connection, messages, etc.

As shown in FIG. 3, for example, the space burial can be filmed (e.g., such as via remote cameras 321 contained on a carrier craft 320 or on cameras 331 on the earth 330) and video data is transmitted 322 back to the earth 330 for access by multiple user groups 332. The video data is preferably transmitted back to the server 400, such as via a satellite transmission 430 and the like. Preferably, the field 590 provides substantially real-time images during a predetermined time or event. Alternatively, the images or the like may be recorded and/or re-played at a later time—ranging, for example, from a short time delay to replay at a substantially later date.

In some preferred embodiments, a field 590 or another field is used to present a web cast or a number of web casts in relation to a space burial service or the like—e.g., displaying various images in relation to the service or the like and, if desired, including a corresponding audio component. The web cast may include a real-time “live” web cast of the launch of the mission, or of the separation of a spacecraft 310 from a carrier craft 320, and/or of a memorial service conducted either in space or on the earth or the like. Alternatively, the web cast or the like may be recorded and/or replayed at a later time-ranging, for example, from a short time delay to replay at a substantially later date. The web cast may include priests or other commentators that are visually observable on the web page and/or that provide verbal commentary along with the web cast.

In some embodiments, members of the public are charged to view the webcast—such as, enabling viewing only after receipt of payment therefore via, for example, on-line credit card payments, virtual wallet payments or via other electronic payment means. In some embodiments, users will be enabled to view the webcast after entering a particular user identification and/or password in order to limit attendance or viewing of the webcast to selected family and/or friends.

In some embodiments, the web cast can include a streaming media presentation that is transmitted to users' local computers. The playback of the streaming media can be carried out by a suitable streaming media player, which could be executed on the users' local computer as a plug-in module for a browser application. Some examples of suitable streaming media players include the MICROSOFT MEDIAPLAYER, the APPLE COMPUTER QUICKTIME and the REALVIDEO or REALPLAYER programs provided by REAL NETWORKS. In addition, the present invention could use other available streaming players or the like.

D. Participation In Services

In some embodiments of the invention, individuals at remote computers can actively participate in a memorial service by, for example, providing on-line eulogies or the like that can be viewed over the Internet. For example, a web page may be provided with links or windows that enable individuals to audibly and/or visually communicate on-line, e.g., using programming similar to Microsoft's NET MEETING or using other video and/or audio conference programming, multi-point data conference programming, Internet telephony, etc.

In this manner, remote individuals may be able to provide statements, eulogies or the like in substantially real-time that are incorporated into a ceremony, memorial service or the like. In addition or alternatively, users may be able to submit pre-recorded statements or the like via the web site. In addition or alternately, in some cases, a pre-recorded statement or the like may be provided by the deceased himself or herself. In the latter case, the web site preferably includes means by which an individual can pre-submit his or her statement or the like in advance of his or her death or passage.

In some preferred embodiments, an administrator can have control of the on-line service in such a manner as to manage or orchestrate the on-line service—such as, e.g., selecting individuals to present statements (e.g., sequentially or the like). In this manner, for example, a memorial service could include a basic memorial service presentation (e.g., by a priest, commentator or the like) and additional presentations by remote individuals as discussed above.

In some preferred embodiments, the web site can include an on-line “signup” form for individuals to enter their names as participants to make eulogies or the like. In some embodiments, the number of participants can be chosen (e.g., on-line) by the individual initially registering for the on-line service on behalf of the deceased. In addition, in some embodiments, the registering individual can select a particular time limit for the presentation (e.g., a limited time per person and/or a limited total overall time).

E. On-Line Gifts and Donations

In some preferred embodiments of the invention, the on-line web site can include options to make purchases 580. This includes, for example, links to addresses such as uniform resource locators (URLs) of other web sites or other mechanisms for redirecting users to other on-line sites, such as one or more of the following: a) a link to a floral service enabling individuals to send flowers to the family or friends of the deceased, b) a link to a card service enabling individuals to send condolence cards or the like to the family or friends of the deceased, and/or c) a link to an on-line charity donation service enabling individuals to make on-line donations to one or more charities on behalf of the deceased. In examples a) and b), addresses can be preregistered or pre-filled to facilitate entry by individuals desiring to send flowers, cards or other items. In example c), a specific charity can be pre-selected or pre-filled by the deceased (e.g., the deceased may pre-register with the service on-line as discussed herein or such may be in the deceased's will or the like) or the family or friends of the deceased. Moreover, in example c), individuals can be added to a list of contributors that are posted on the web site along with information regarding the deceased.

F. Terrestrial Memorials

a) Website Memorials

According to preferred embodiments of the invention, the web site includes permanent or semi-permanent displays as memorials for the deceased. In this regard, the web site preferably includes a search engine or other means by which a name of an individual can be located in order to “click on” or to otherwise select the memorial for that individual.

Each web site memorial can include: a) images of the individual and/or the individual's family or friends, b) biographical information on the individual, c) video clips (e.g., of a funeral or another event in the life of the individual, e.g., weddings, graduations or the like), d) a friends and/or family comment section wherein statements by family and friends can be retrieved (e.g., this can include written statements, audio statements, video statements and/or other statements or presentations).

In the preferred embodiments, the web site will include a list of individuals that are included on a space burial flight, and individual web site memorials will be able to be selected for review. In some preferred embodiments, the web site memorials or portions of the web site memorials (e.g., such as personal statements, personal images and/or videos or the like) can be secured behind a firewall or the like such that users can only access the memorials or portions thereof with user identifications and/or passwords. In other embodiments, individuals can be provided with a comment web site section at which the users can submit comments to or on behalf of their deceased loved ones--for example, posting messages on their loved one's birthdays or the like.

In this latter case, preferably such comments and/or message boards are secured behind firewalls or the like for privacy.

b) Physical Object Memorials

In some preferred embodiments, physical object memorials can be provided such as wall mountable displays and/or table top displays. For example, such displays can include information about the deceased (e.g., biographies, pictures or the like), information regarding a space burial flight in which the deceased's ashes or the like are included, replicas of capsules containing the deceased ashes or actual capsules containing a portion of the ashes of the deceased, and/or other pictures or the like.

In some preferred embodiments, physical object memorials can be purchased on-line via the web site. Accordingly, on-line users or viewers of on-line memorials services can thus purchase additional memorial products in relation to the memorial services.

G. Mission Status

In other preferred embodiments, wherein a deceased's remains and/or a portion thereof are contained on a spacecraft or the like, a link is preferably provided to direct a viewer to other web pages or the like to obtain information regarding the spacecraft mission status. Preferably, a specific region is provided for a user to “click on” to be presented with information related to past mission history and facts (e.g., including images of the voyage to date, information regarding the development of the mission, background information of the mission, technical information regarding the construction of the spacecraft, past flight path information of the mission, etc.).

Preferably, a specific region is provided for a user to “click on” to be presented with information related to present mission status and facts (e.g., including images of the present location of the mission, the specific distance of the spacecraft, the fuel remaining on the spacecraft, various other technical information of the spacecraft status, or the like). Preferably, a specific region is provided for a user to “click on” to be presented with information related to anticipated future mission status and facts (e.g., including illustrations of the anticipated flight path and schedule, the anticipated development of the mission, etc.).

In some embodiments of the invention, the spacecraft is optically tracked via terrestrial telescopes (or, alternately, via non-terrestrial telescopes) during the space mission. Preferably, the optical image of the spacecraft is transmitted for viewing by the participants. In some preferred embodiments, the optical tracking is performed for a substantial period of time and is substantially continuously made available for viewing via an on-line web site, e.g., via a streaming media presentation or the like.

In some embodiments, the spacecraft is tracked via radar during the space mission. Preferably, the location of the spacecraft is transmitted for viewing (e.g., on an on-line radar screen image) by the participants. Preferably, the radar tracking is performed for a very substantial period of time over the course of the mission. In this manner, mission status can be updated and/or viewed on a continuing basis.

H. On-Line Communications

Additionally, the web page also preferably includes one or more regions for participant and/or public communication. Preferably, a region is provided to enable members of the public to post comments on message boards in relation to space burial mission or the like. Preferably, a region is provided to enable only certain members of the public having user identifications and/or passwords (e.g., alphanumeric identification codes) to view and/or post comments. Thus, in some embodiments, certain message boards can be limited to, for example, family members and/or close friends of the deceased in the space burial missions.

Additionally, the web page also preferably includes a region to enable members of the public to “chat” on-line in substantially real-time about the space burial mission or the like. Most preferably, a region is provided to enable only certain members of the public having user identifications and/or passwords (e.g., alphanumeric identification codes) to view and/or participate in certain chat sessions. Thus, in some embodiments, certain chat rooms or sessions can be limited to, for example, family members and/or close friends of the deceased.

While the present invention has been described above with respect to preferred embodiments of the invention, the present invention is not limited thereto, but encompasses all other modifications, variations and embodiments that would be apparent to those in the art based on this disclosure. For example, as noted above, while preferred embodiments of the present invention relate to space burials, various aspects of the present invention can be applied in other contexts. For example, as set forth above, various user interface features can be applied in terrestrial and other burials, memorial services, celebrations, ceremonies, and a variety of other events.

Those skilled in the art will readily appreciate that many modifications and variations are possible in the exemplary embodiments without materially departing from the novel teachings and advantages of the invention. Accordingly, all such modifications and variations are intended to be included within the scope of this invention.

1. A method for broadcasting an event, comprising the steps of:
broadcasting an event to at least two recipients in disparate geographical locations, wherein each recipient is assigned to at least one of multiple interest groups; and
supplementing the broadcast of the event with content broadcast to at least one of the multiple interest groups.

2 .The method of claim 1 further comprising the step of:
configuring the broadcast such that at least some of the supplemental content is supplied by the at least one recipient.

3. The method of claim 1 further comprising the step of:
broadcasting the event via the Internet.

4. The method of claim 3 further comprising the step of:
organizing the multiple interest groups to memorialize at least one deceased individual.

5. The method of claim 4 further comprising the steps of:
launching cremated remains of the at least one deceased individual into outer space; and
relating the broadcasting of the event to the launching.

6. The method of claim 5 further comprising the step of:
configuring the broadcast such that at least some of the supplemental content is supplied by the recipients.

7. The method of claim 6 wherein at least some of the supplemental content is different among the multiple interest groups.

8. The method of claim 7 wherein at least some of the supplemental content includes remembrances of the at least one deceased individual.

9. The method of claim 8 further comprising the step of:
limiting access to the supplemental content to authorized recipients.

10. The method of claim 1 wherein at least some of the supplemental content includes remembrances of at least one deceased individual.

11. The method of claim 1 further comprising the step of:
limiting access to the supplemental content to authorized recipients.

12.The method of claim 1 further comprising the step of:
including information in the broadcast related to a status of a mission.

13. The method of claim 12 wherein the mission includes a space launch.

14.The method of claim 5 wherein the supplemental content comprises an opportunity to make on-line gifts or donations.

15. The method of claim 5 wherein the supplemental content comprises an opportunity to purchase physical objects related to a memorial service .

16.The method of claim 8 further comprising the step of:
configuring the broadcast to include at least two recipients to engage in web chatting.

17. A system for providing customized observance of an event broadcasted via a communication network, comprising:
an operator site, said site transmitting said broadcast to at least one participant at a user site;
a server providing said broadcast via said communication network to said user site; and
a processor permitting said participant to customize an output of said broadcast at said user site by supplementing said broadcast with content, said content determined by said participant.

18. The system in accordance with claim 17, wherein said content comprises a personal message.

19. The system in accordance with claim 17, wherein said content is a streaming video.

20. The system in accordance with claim 17, wherein said communication network is the Internet.

21 .The system in accordance with claim 17, wherein said event is a memorial service.

22. The system in accordance with claim 21, wherein said memorial service is a space burial.

23. The system in accordance with claim 17, wherein said user site further comprises:
a microphone for said participant to provide audio content to supplement said broadcast; and
a video camera for said participant to provide visual content to supplement said broadcast.

24. The system in accordance with claim 1 7, wherein said content is transmitted to a participant at a second user site via said communication network.

25. A method for providing customized observance of an event broadcasted via a communication network, comprising the steps of:
an operator site broadcasting to at least one participant at a user site from the operator site;
accessing said broadcast via said communication network from said user site; and
customizing an output of said broadcast at said user site by permitting said at least one participant to supplement said broadcast with content, said content being determined by said at least one participant.

26. The method in accordance with claim 25, further comprising the step of:
configuring said output as a video display.

27. The method in accordance with claim 25, further comprising the step of:
configuring said output as an audio output.

28. The method in accordance with claim 25, wherein said communication network is the Internet.

29. The method in accordance with claim 25, wherein said event is a memorial service.

30. The method in accordance with claim 29, wherein said memorial service is a space burial.

31. The method in accordance with claim 25, wherein said content consists of a personal message.

32. The method in accordance with claim 25, further comprising the step of:
transmitting said customization of said output to a participant at a second user site via said communication network.

33. The method in accordance with claim 25, further comprising the steps of:
preparing said content in advance of said broadcasted event;
storing said content in a memory; and
retrieving said content with a processor coupled to said memory for customizing said broadcast of said event.

34. A method of user participation in a memorial service for a space burial, comprising:
a) providing a web site or other graphical user interface for users to access via the Internet or via another computer network;
b) displaying a webcast via said web site of a memorial service on behalf of at least one deceased individual having remains included in a space burial mission; and
c) having users view the webcast from remote computers connected to said computer network.

35. A method of user participation in a space burial, comprising:
a) providing a server programmed to create a web site or graphical user interface accessible via the Internet or a computer network;
b) providing a space vehicle having a deceased individual cargo section;
c) obtaining video images of said space vehicle during travel of said space vehicle; and
d) creating an Internet or computer network broadcast of said video images;
e) having a member of the public access and view said broadcast via a local computer over the Internet or computer network in substantially real-time.

36. A method of personalizing a space burial service, comprising:
a)programming a web site or graphical user interface accessible via the Internet or another computer network;
b) launching a space vehicle having a deceased individual cargo section;
c) accessing the web site via the Internet or computer network at a local computer remote from the server;
d) inputting information via said web site related to a memorial service on behalf of at least one of said deceased individuals; and
e) adapting an on-line memorial service based on said information submitted.

37. A method of user participation in memorial services for space burials, comprising:
a) providing a web site or other graphical user interface for users to access via the Internet or via another computer network;
b) displaying a webcast via the web site of a memorial service on behalf of at least one deceased individual having remains included in a space burial mission; and
c) having users participate in the memorial service by submitting statements on-line from remote computers connected to said computer network.

38. The method of claim 37, further including submitting the user statements in substantially real-time with the memorial service.

39. The method of claim 37, further including pre-recording and submitting the user statements in advance of the memorial service.

40. A method of personalizing a memorial service, comprising:
a) programming a web site or graphical user interface accessible via the Internet or a computer network;
b) accessing the web site via the Internet or computer network at a local computer remote from the server;
c) inputting information via said web site related to a memorial service on behalf of at least one of said deceased individuals;
d) adapting an on-line memorial service based on said information submitted.

41. A method of user participation in memorial services, comprising:
a) providing a web site or other graphical user interface for users to access via the Internet or via another computer network;
b) displaying a webcast via the web site of a memorial service on behalf of at least one deceased individual; and
c) having users participate in the memorial service by submitting statements on-line from remote computers connected to said computer network.
